(19) United States
(12) Patent Application Publication
(10) Pub. No.: US 2006/0175432 A1
(43) Pub. Date: Aug. 10, 2006

(54) APPARATUS AND METHOD FOR APPLYING CONTROLLED PATTERNS OF LIQUID

(76) Inventors: Reuben Brock, Suwanee, GA (US); Greg Clark, Alpharetta, GA (US); Paul Schmidt, Sugarhill, GA (US)

Correspondence Address: WOOD, HERRON & EVANS, LLP (NORDSON), 2700 CAREW TOWER, 441 VINE STREET, CINCINNATI, OH, 45202, US

(21) Appl. No.: 10/905,824

(22) Filed: Jan. 21, 2005

(51) Int. Cl. B05B 1/28

(52) U.S. Cl. 239/298; 239/300; 239/69; 239/290; 239/417.5

(57) ABSTRACT

An apparatus for dispensing a controlled pattern of liquid material, such as hot melt adhesive, includes a pump, a liquid applicator coupled to the pump, a pressure transducer located in the liquid path between the applicator and the pump and a controller coupled with the pressure transducer. The pump supplies liquid to the liquid applicator at a variable pressure. The pressure transducer detects the pressure of the liquid and produces a signal indicating a sensed pressure. The controller receives the signal and changes the pressure of the process air discharging from the applicator based on the received signal.

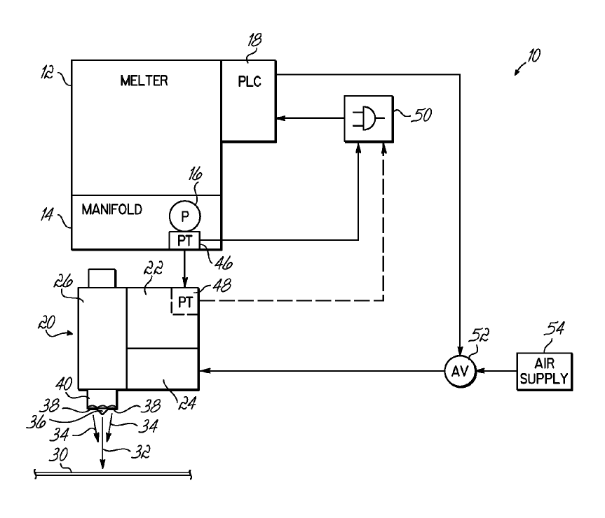

### FIELD OF THE INVENTION

The invention generally relates to air assisted liquid dispensing systems and, more specifically, apparatus for dispensing controlled patterns of hot melt adhesive or other viscous liquids in the form of filaments.

### BACKGROUND OF THE INVENTION

Various types of liquid dispensing systems utilize process air or pattern air to effect a desired movement, attenuation or other result on a viscous liquid. These systems can include hot melt adhesive dispensing apparatus or other apparatus for dispensing filaments of viscous liquid. Many different patterns may be produced by the apparatus depending on the application, but examples include swirl patterns, sinusoidal patterns, zig zag patterns, and other back and forth patterns which form a wider adhesive contact area on the substrate than would a straight bead. Other patterns include random filament deposition such as traditional meltblown technology, and other newer technology which creates discrete bond points using filaments which may break between the bond points during deposition onto a strand, for example.

The present invention can generally relate to various liquid dispensing systems, such as melter/applicator units for depositing or applying thermoplastic material, controlled fiberization techniques, meltblown techniques and other technology such as mentioned above, using any suitable equipment. When applying thermoplastic adhesive or so-called hot melt adhesive patterns onto moving substrates, various challenges exist especially during speed transitions of the substrate. For example, as the line speed of the substrate increases, gear pumps which supply the adhesive to the applicators will turn faster so that adhesive is supplied at a faster rate to the faster moving substrate. Likewise, the pressure of the process air will also be increased to maintain a consistent adhesive pattern. Unfortunately, due to response delays in the hydraulic system, the air pressure will increase quicker than the hydraulic pressure and this can result in temporarily inconsistent adhesive patterns deposited on the substrate until steady state liquid and air pressures exist at the applicator. The hydraulic portion of the system typically has a slower response time due to the length of adhesive hoses and other liquid passages in the system and because air will naturally respond more quickly to pressure changes than will a viscous liquid such as hot melt adhesive. The inconsistent adhesive patterns can result in either product scrap or areas of less than optimum product quality.

It would therefore be desirable to provide a liquid applicator system and method which can more consistently maintain an adhesive pattern during pressure changes of the liquid in the dispensing process.

### SUMMARY OF THE INVENTION

The present invention generally provides an apparatus for dispensing a controlled pattern of liquid material in an air assisted manner. The pattern may be more consistently maintained despite changes in liquid pressure which would otherwise negatively affect the pattern and cause inconsistencies in the pattern applied to a substrate.

More specifically, the apparatus comprises a pump having an outlet for supplying the liquid at a variable pressure. A liquid applicator is coupled to the pump for receiving the liquid and includes a nozzle for discharging the liquid. A process air input port in the applicator receives pressurized process air and a process air discharge port in the nozzle discharges the pressurized process air at the discharging liquid. A liquid path extends from the outlet of the pump to the nozzle. A pressure transducer is located in the liquid path and detects the pressure of the liquid in the path. The transducer then produces a signal indicating a sensed pressure of the liquid. A controller is coupled with the pressure transducer and receives the signal, directly or indirectly through other control components, and changes the pressure of the process air discharging from the applicator based on the received signal.

The outlet of the pump is preferably coupled to a manifold and the pressure transducer may, for example, be located in the manifold or in the applicator. The pressure of the process air is preferably increased after detecting an increase in the pressure of the liquid in the liquid path. The opposite is also true, i.e., the control decreases the pressure of the process air after detecting a decrease in the pressure of the liquid in the liquid path. In the preferred embodiment, an adjustable pressure control valve is coupled to the process air input port and is configured to receive the pressurized process air and direct the pressurized process air to the process air input port. The pressure control valve is further electrically coupled to the controller and receives a command from the controller to change the pressure of the process air directed to the process air input port.

The invention further encompasses a method of dispensing a controlled pattern of liquid material. Generally, the method involves moving a substrate past an applicator. Liquid discharges from the applicator toward the substrate at a first liquid pressure. Process air also discharges at a first air pressure from the applicator at the discharged liquid. When the first liquid pressure changes to a different, second liquid pressure, this change in pressure is sensed and, as a result, the air pressure is adjusted to a second, different air pressure.

To determine the appropriate value for the second air pressure, the controller may, for example, either calculate the second air pressure based on an algorithm appropriate for the particular application, or select a value for the second air pressure in a look up table stored in memory based on empirical information.

Additional details, features and advantages of the present invention will become more readily apparent to those of ordinary skill upon further review of the following detailed description of the invention accompanied by the drawing of one exemplary and preferred embodiment of the invention.

### BRIEF DESCRIPTION OF THE DRAWING

The drawing is a diagrammatic illustration of a hot melt adhesive dispensing apparatus constructed in accordance with the invention.

### DETAILED DESCRIPTION OF THE PREFERRED EMBODIMENT

The FIGURE diagrammatically shows an illustrative hot melt adhesive dispensing system 10 constructed in accordance with the inventive principles. The system generally includes a melter unit 12 for receiving solid or semi-solid thermoplastic hot melt adhesive material. Melter unit 12 includes a manifold 14, a pump 16, and a programmable logic controller (PLC) unit 18 as part of the melter unit. Optionally, these portions of the melter unit 12 may be separate components. A typical hot melt applicator 20 may be used in carrying out the invention and, for example, can include a liquid manifold or service block 22, an air manifold 24 and a valve module 26. Applicator valve module 26 may, for example, be of any number of different types depending on the intended use, but one example is the CF200 module available from Nordson Corporation, Westlake, Ohio. Valve module 26 receives process air from air manifold 24 and molten, pressurized liquid from liquid manifold or service block 22 and dispenses the liquid in a desired, air assisted manner onto a substrate 30. The liquid may be deposited as a filament as indicated by arrow 32 and is impacted upon discharge by process air as indicated by arrows 34 after being discharged from respective orifices or outlets 36, 38 associated with a nozzle 40 of the module 26. As discussed above, any number of different liquid patterns may be produced on any desired substrate, such as flat sheets of material or strands of material.

In accordance with the inventive concepts, a liquid pressure transducer may be positioned anywhere in the flow path for the liquid between the liquid supply, such as melter unit 12, and the applicator 20. As shown, a pressure transducer 46 may be positioned in the manifold 14 or, optionally, a pressure transducer 48 may be located in the applicator 20 which, in this case, may be the manifold or service block 22 associated with the valve module 26. A pressure signal taken from either pressure transducer 46 or 40 is sent to the melter PLC 18 through an analog input 50. This signal is then conditioned through a calculation or look up table to determine the optimum process air pressure set point for the process air 34. The signal is transmitted from the PLC 18 using an analog input to a pressure control valve 52. By controlling the electrical current to the pressure control valve 52, the output pressure to the process air manifold 24 may be adjusted according to the command sent by the PLC 18. Thus, the pressurized air received from an air supply 54 may be adjusted such that the process air 34 discharging from the nozzle 40 changes as quickly as possible with changes in the hydraulic pressure of the liquid 32 discharging from the nozzle 40. Generally, when the liquid pressure increases, the process air pressure will be commanded to increase proportionately and when the liquid pressure decreases, the process air pressure issuing from the nozzle 40 will likewise be commanded to decrease proportionately.

One exemplary manner of determining an optimum process air pressure based on the hydraulic system pressure involves operating a hot melt adhesive dispensing system at a relatively low hydraulic pressure (H_{L}) and, by a trial and error method of adjusting the process air pressure (A_{L}), subjectively determining what process air pressure gives the desired adhesive pattern. Either before or after this step, the system is also operated at a relatively high hydraulic pressure (H_{H}) and the process air pressure is adjusted to a level (A_{H}) until achieving the desired adhesive pattern. The controller can then be programmed to determine the required process air pressure (A_{REQ}) based on the existing hydraulic pressure (H_{EXT}) during normal operation of the system. An algorithm used by the controller to set the required process air pressure can be used, where:
H_{L}=Low Hydraulic Pressure
H_{H}=High Hydraulic Pressure
A_{L}=Low Process Air Pressure
A_{H}=High Process Air Pressure
H_{EXT}=Existing Hydraulic Pressure During System Operation
A_{REQ}=Required Process Air Pressure
   The exemplary algorithm is:
   A_{REQ}=[(H_{EXT}−H_{L})*(A_{H}−A_{L})/(H_{H}−H_{L})]+A_{L}

While the present invention has been illustrated by a description of various preferred embodiments and while these embodiments has been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims, wherein we claim:

1. An apparatus for dispensing a controlled pattern of liquid material, comprising:
a pump having an outlet for supplying the liquid at a variable pressure,
a liquid applicator coupled to said pump for receiving the liquid and including a nozzle for discharging the liquid, a process air input port for receiving pressurized process air and a process air discharge port for discharging the pressurized process air,
a liquid path extending from said outlet of said pump to said nozzle,
a pressure transducer located in said liquid path to detect the pressure of the liquid in said path and produce a signal indicating a sensed pressure of the liquid, and
a controller receiving said signal and changing the pressure of the process air discharging from said applicator based on said received signal.

2. The apparatus of claim 1, further comprising a manifold coupled to said outlet of said pump and said pressure transducer is located in said manifold.

3. The apparatus of claim 1, wherein said pressure transducer is located in said applicator.

4. (canceled)

5. (canceled)

6. The apparatus of claim 1, further comprising:
an adjustable pressure control valve for receiving the pressurized process air and directing the pressurized process air to said process air input port, said controller generating a command signal in response to said sensed liquid pressure signal, and said pressure control valve receiving said command signal from said controller to change the pressure of the process air directed to said process air input port.

7. A method of dispensing a controlled pattern of liquid material, comprising:
discharging liquid from the applicator at a liquid pressure, discharging process air from the applicator at an air pressure,
sensing a change in said liquid pressure, and
changing the air pressure to another different air pressure based on the change sensed in the liquid pressure.

8. The method of claim 7, wherein the liquid is a thermoplastic material supplied by a melter unit having a pump with an outlet coupled to a manifold, and further comprising:
supplying the liquid at the liquid pressure from the manifold to the applicator, and
sensing the change in the liquid pressure in the manifold.

9. The method of claim 7, wherein the change in the liquid pressure is sensed in the applicator.

10. (canceled)

11. (canceled)

12. The method of claim 7, wherein changing the air pressure to another, different air pressure further comprises:
calculating the different air pressure based on an algorithm.

13. The method of claim 7, wherein changing the air pressure to another, different air pressure further comprises:
determining the different air pressure based on a look up table stored in a memory.
